(19) United States
(12) Patent Application Publication
(10) Pub. No.: US 2026/0276203 A1
(43) Pub. Date: Sep. 17, 2026

(54) SYSTEMS AND METHODS FOR BATTERY-ASSISTED COOKING IN AN OVEN RANGE APPLIANCE

(71) Applicant: Haier US Appliance Solutions, Inc., Wilmington, DE (US)

(72) Inventor: Eric Scott Johnson, Louisville, KY (US)

(21) Appl. No.: 19/075,932

(22) Filed: Mar. 11, 2025

(51) Int. Cl. F24C 7/08; H02J 9/06

(52) U.S. Cl. CPC F24C 7/087; H02J 9/068

(57) ABSTRACT

A cooking appliance including one or more electric heaters, a main power connection to a main supply of electrical power at a first voltage, an auxiliary power connection to a battery supply of electrical power at a second voltage, and a voltage controller for regulating the electrical power from the battery supply to at least one of the one or more electric heaters. A controller is configured to receive a call for heat from the one or more electric heaters, determine that a total requested battery power draw associated with the call for heat is greater than a battery power maximum threshold, calculate a reduced battery power draw that is less or equal to the battery power maximum threshold, and operate the voltage controller to supply the reduced battery power draw to the one or more electric heaters.

### FIELD OF THE INVENTION

The present subject matter relates generally to cooking appliances, and more particularly, to systems and methods of operating a battery-assisted cooking appliance.

### BACKGROUND OF THE INVENTION

Conventional residential and commercial cooking appliances generally include a cabinet that includes a cooking chamber (e.g., an oven chamber) for receipt of food items for cooking. Multiple heating elements are positioned within the cooking chamber to provide heat to food items located therein. The heating elements can include, for example, radiant heating elements, such as a bake heating assembly positioned at a bottom of the cooking chamber and/or a separate broiler heating assembly positioned at a top of the cooking chamber. In addition, cooking appliances commonly include a cooktop positioned on top of the oven chamber and having a plurality of gas burners or electric heating elements for heating pots, pans, etc. These cooking appliances are often called “oven range appliances,” “oven ranges,” or simply “ranges.”

Notably, conventional cooking appliances that include electric heating elements in the oven chamber and electric heating elements on the cooktop are powered by a main electricity supply. However, a user's kitchen may be wired for a first voltage (e.g., 12 0VAC for a gas range), requiring rewiring by an electrician to use a conventional electric cooking appliance, cooktop, and/or range that operates at a second voltage (e.g., 240 VAC). Accordingly, purchasers of electric cooking appliances that operate at the second voltage may be disappointed when their product cannot be used when installed or when they need to hire an electrician to rewire prior to operation. A battery with a second voltage could be used to remove the need for rewiring, where the battery could be charged and/or powered by the main supply providing a first voltage. However, such a battery-assisted construction may result in limited battery life, exhibit poor performance and minimal available power to oven heaters, and reduce performance when heater power adjustments are needed to remain below battery and/or main supply maximum power thresholds.

Accordingly, an electric cooking appliance that utilizes a combination of main and battery power is desirable. More specifically, control hardware and methods of operating a battery-assisted cooking appliance in a manner that removes the need for rewiring, increases battery life, increases available power to heaters, and reduces change to performance when battery power draw exceeds battery max power threshold would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, a cooking appliance is provided including one or more electric heaters, a main power connection to a main supply of electrical power at a first voltage, an auxiliary power connection to a battery supply of electrical power at a second voltage, a voltage controller for regulating the electrical power from the battery supply, and a controller operably coupled to the voltage controller. The controller is configured to receive a call for heat requesting activation of at least one of the one or more electric heaters, determine that a total requested battery power draw associated with the call for heat is greater than a battery power maximum threshold, calculate a reduced battery power draw that is less than or equal to the battery power maximum threshold, and operate the voltage controller to supply the reduced battery power draw to the one or more electric heaters.

In another exemplary embodiment, a method of operating a cooking appliance is provided. The cooking appliance includes a one or more electric heaters, a main power connection to a main supply of electrical power at a first voltage, an auxiliary power connection to a battery supply of electrical power at a second voltage, and a voltage controller for regulating the electrical power from the battery supply. The method includes receiving a call for heat requesting activation of at least one of the one or more electric heaters, determining that a total requested battery power draw associated with the call for heat is greater than a battery power maximum threshold, calculating a reduced battery power draw that is less than or equal to the battery power maximum threshold, and operating the voltage controller to supply the reduced battery power draw to the one or more electric heaters.

According to still another example embodiment, a cooking appliance is provided including one or more electric heaters, a main power connection to a main supply of electrical power at a first voltage, an auxiliary power connection to a battery supply of electrical power at a second voltage, a voltage controller for regulating the electrical power from the battery supply, and a controller operably coupled to the voltage controller. The controller is configured to determine that a timed cooking mode is active, determine that a battery charge of the battery supply is not sufficient to complete the timed cooking mode, calculate a modified power draw that permits that timed cooking mode to complete using the battery charge, and operate the voltage controller to supply the modified power draw to the one or more electric heaters.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front perspective view of a cooking appliance according to an example embodiment of the present subject matter.

FIG. 2 provides a front perspective view of the example cooking appliance of FIG. 1 with a door in the open position according to an example embodiment of the present subject matter.

FIG. 3 provides a side, schematic view of the example cooking appliance of FIG. 1 according to an example embodiment of the present subject matter.

FIG. 4 provides a side, schematic view of a heating system of the example cooking appliance of FIG. 1 according to an example embodiment of the present subject matter.

FIG. 5 provides a side, schematic view of a heating system of the example cooking appliance of FIG. 1 according to another example embodiment of the present subject matter.

FIG. 6 provides an electrical schematic view of a heating system and power switching system of the example cooking appliance of FIG. 1 according to an example embodiment of the present subject matter.

FIG. 7 provides a table of potential power supply scenarios for powering an oven chamber heater and a cooktop heater of the example cooking appliance of FIG. 1 according to an example embodiment of the present subject matter.

FIG. 8 provides a method of operating a heating system of the example cooking appliance of FIG. 1 according to an example embodiment of the present subject matter.

FIG. 9 provides a method of operating a heating system of the example cooking appliance of FIG. 1 according to an example embodiment of the present subject matter.

FIG. 10 provides a method of operating a heating system of the example cooking appliance of FIG. 1 according to an example embodiment of the present subject matter.

FIG. 11 provides a method of operating a heating system of the example cooking appliance of FIG. 1 according to an example embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As explained herein, aspects of the present subject matter are generally directed to a control system that powers an oven, a cooktop, and/or a cooking range using a combination of mains electric supply and battery power. The construction may enable a method that maximizes power use from the main supply, extending battery life. The cooking range, the electric cooktop, and/or the oven heater may include a power connection to mains supply with a first voltage (e.g., 120 VAC), a battery with a second voltage (e.g., 230 VDC), and a controller that receives and distributes power to heaters. One or more switches may be utilized that gate power to oven and/or cooktop heaters from main supply and/or battery. Further, one or more oven heaters may include two or more stages, one powered from the main supply and another powered from the battery.

According to an example embodiment, oven heaters may be powered from a main supply at a first voltage (e.g., 120 VAC) and/or a battery at a second voltage (e.g., 230 VDC). Control hardware and methods are described herein to power an oven, cooktop, and/or cooking range using a combination of main and battery power. A pulse width modulation (PWM) controller (or battery voltage controller) may enable reduction of battery-driven heater power to remain under a battery's max power output threshold, extend operation when battery is at low charge, and/or reduce battery power draw intensity to reduce battery heat generation and/or extend battery life.

According to an example embodiment, a TRIAC controller may enable reduction of power delivered to a first heater from the main supply, enabling operation of a second heater from the main supply instead of the battery. The TRIAC controller thus maximizes power drawn from the main supply and/or reduces use of battery power, extending battery life and/or or improving performance.

The control hardware and methods described herein enable minimization of the power demand on the battery, increasing available cook time before battery discharges and extending battery life by reducing high-intensity use. In addition, the hardware and methods increase performance by enabling maximization of available power to oven heaters, minimize performance impact when heater power adjustments are needed to remain below battery and/or main supply max power thresholds, and reduce power demand on the battery, reducing self-heating and increasing its life.

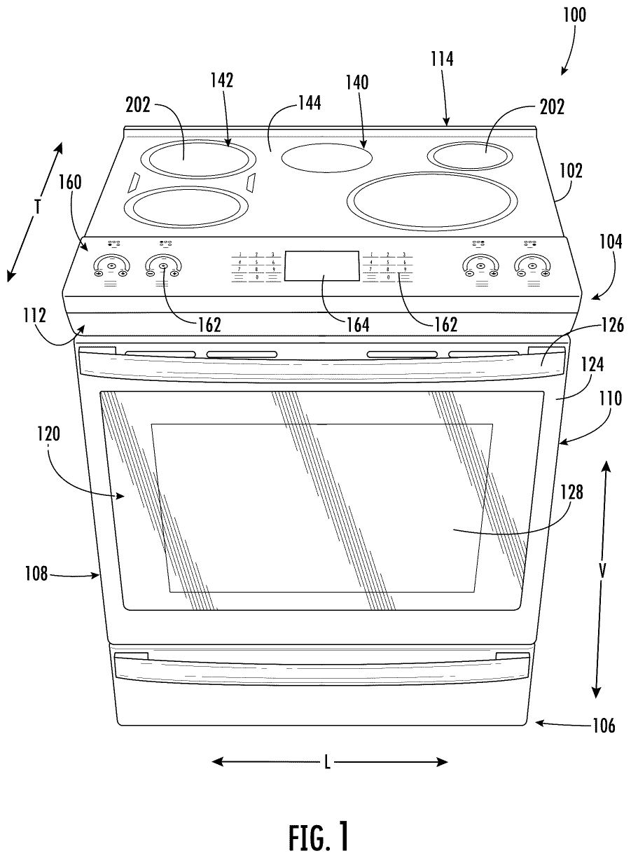

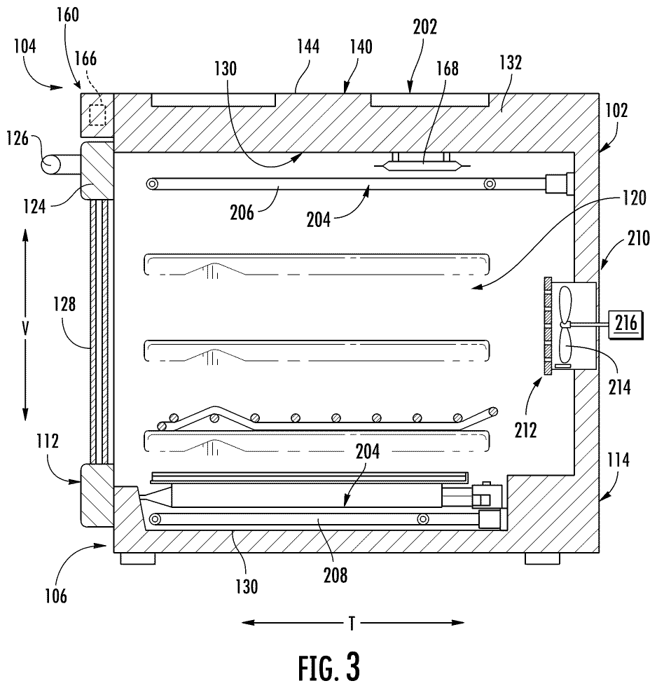

FIG. 1 provides a front, perspective view of a cooking appliance 100 as may be employed with the present subject matter. Cooking appliance 100 generally defines a vertical direction V, a lateral direction L, and a transverse direction T, each of which is mutually perpendicular, such that an orthogonal coordinate system is generally defined. As illustrated, cooking appliance 100 includes an insulated cabinet 102. Cabinet 102 of cooking appliance 100 extends between a top 104 and a bottom 106 along the vertical direction V, between a first side 108 (left side when viewed from front) and a second side 110 (right side when viewed from front) along the lateral direction L, and between a front 112 and a rear 114 (FIG. 3) along the transverse direction T.

Within cabinet 102 is a single cooking chamber 120 which is configured for the receipt of one or more food items to be cooked. However, it should be appreciated that cooking appliance 100 is provided by way of example only, and aspects of the present subject matter may be used in any suitable cooking appliance, such as a double oven range appliance. Thus, the example embodiment shown in FIG. 1 is not intended to limit the present subject matter to any particular cooking chamber configuration or arrangement. Indeed, aspects of the present subject matter may be applied to any suitable cooking appliance.

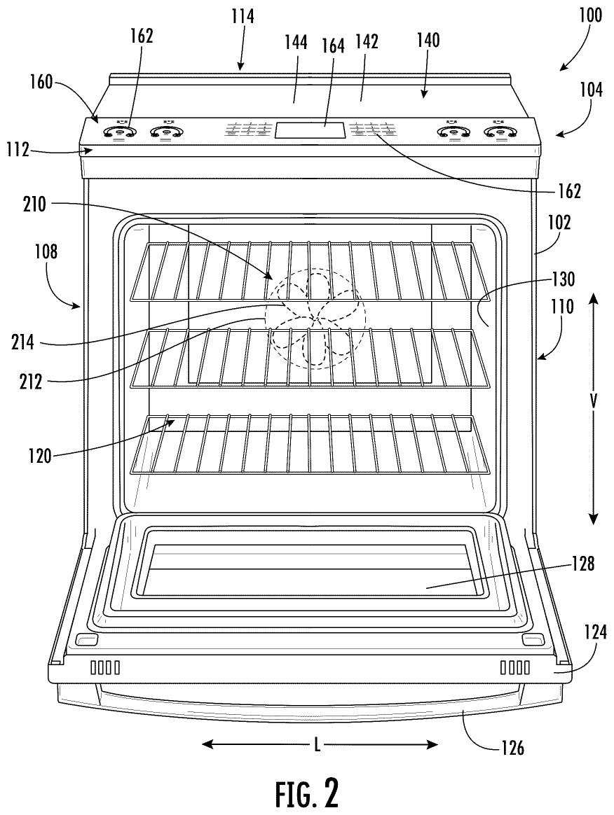

Referring now also to FIGS. 2 and 3, cooking appliance 100 includes a door 124 rotatably attached to cabinet 102 in order to permit selective access to cooking chamber 120. Handle 126 is mounted to door 124 to assist a user with opening and closing door 124 in order to access cooking chamber 120. As an example, a user can pull on handle 126 mounted to door 124 to open or close door 124 and access cooking chamber 120. One or more transparent viewing windows 128 (FIG. 1) may be defined within door 124 to provide for viewing the contents of cooking chamber 120 when door 124 is closed and also assist with insulating cooking chamber 120.

Cooking chamber 120 is defined by a plurality of chamber walls 130. Specifically, cooking chamber 120 may be defined by a top wall, a rear wall, a bottom wall, and two sidewalls 130. These chamber walls 130 may be joined together to define an opening through which a user may selectively access cooking chamber 120 by opening door 124. In order to insulate cooking chamber 120, cooking appliance 100 includes an insulating gap defined between the chamber walls 130 and cabinet 102. According to an exemplary embodiment, the insulation gap is filled with an insulating material 132, such as insulating foam or fiberglass, for insulating cooking chamber 120.

Cooking appliance 100 also includes a cooktop 140. Cooktop 140 is positioned at or adjacent top 104 of cabinet 102 such that it is positioned above cooking chamber 120. Specifically, cooktop 140 includes a top panel 142 positioned proximate top 104 of cabinet 102. By way of example, top panel 142 may be constructed of glass, ceramics, enameled steel, and combinations thereof. For example, according to the illustrated embodiment, cooktop includes a ceramic glass panel 144 having a plurality of cooking zones.

Although aspects of the present subject matter are described herein in the context of a single cooking appliance, it should be appreciated that cooking appliance 100 is provided by way of example only. Other oven or range appliances having different configurations, different appearances, and/or different features may also be utilized with the present subject matter, e.g., double ovens, standalone cooktops, etc.

As illustrated, cooking appliance 100 may generally include a user interface panel 160 that is located within convenient reach of a user of the cooking appliance 100. For example, according to the illustrated embodiment, user interface panel 160 is mounted at a front 112 and top 104 corner of cabinet 102, e.g., directly above door 124. Although user interface panel 160 is illustrated as being mounted at a top, front of cabinet 102, it should be appreciated that aspects of the present subject matter may be applicable to other mounting locations of control panels, e.g., such as front mount control panels, rear mount panels, etc. In addition, it should be appreciated that the present subject matter is not limited oven applications but could instead be applied to any other suitable appliance.

For this example embodiment, user interface panel 160 includes control inputs 162 that are each associated with one or more heating elements of cooking appliance 100. In this manner, control inputs 162 allow the user to activate each heating element and determine the amount of heat input provided by each heating element to a cooking food items within cooking chamber 120 or on cooktop 140. Although control inputs 162 are illustrated as touch-sensitive or contact inputs, it should be understood that control inputs 162 and the configuration of cooking appliance 100 shown in FIG. 1 is provided by way of example only. More specifically, user interface panel 160 may include various input components, such as one or more of a variety control knobs, electrical, mechanical or electro-mechanical input devices including rotary dials, push buttons, and touch pads. User interface panel 160 may also be provided with one or more graphical display devices or display components 164, such as a digital or analog display device designed to provide operational feedback or other information to the user such as e.g., whether a particular heating element is activated and/or the rate at which the heating element is set.

User interface panel 160 may be in direct operative communication with a controller 166 of cooking appliance 100, such that user inputs via user interface panel 160 may be directly used to regulate operation of various components of cooking appliance 100. User interface panel 160 of cooking appliance 100 may be in communication with controller 166 via, for example, one or more signal lines or shared communication busses, and signals generated in controller 166 operate cooking appliance 100 in response to user input via user input devices 162. Input/Output (“I/O”) signals may be routed between controller 166 and various operational components of cooking appliance 100 such that operation of cooking appliance 100 can be regulated by controller 166.

Controller 166 is a “processing device” or “controller” and may be embodied as described herein. Controller 166 may include a memory and one or more microprocessors, microcontrollers, application-specific integrated circuits (ASICS), CPUs or the like, such as general or special purpose microprocessors operable to execute programming instructions or micro-control code associated with operation of cooking appliance 100, and controller 166 is not restricted necessarily to a single element. The memory may represent random access memory such as DRAM, or read only memory such as ROM, electrically erasable, programmable read only memory (EEPROM), or FLASH. In one embodiment, the processor executes programming instructions stored in memory. The memory may be a separate component from the processor or may be included onboard within the processor. Alternatively, controller 166 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

In addition, controller 166 may also be communication with one or more sensors, such as temperature sensor 168 (FIG. 3), which may be used to measure temperature inside cooking chamber 120 and provide such measurements to the controller 166. As used herein, “temperature sensor” or the equivalent is intended to refer to any suitable type of temperature measuring system or device positioned at any suitable location for measuring the desired temperature. Thus, for example, temperature sensor 168 may each be any suitable type of temperature sensor, such as a thermistor, a thermocouple, a resistance temperature detector, a semiconductor-based integrated circuit temperature sensor, etc. In addition, temperature sensor 168 may be positioned at any suitable location and may output a signal, such as a voltage, to a controller that is proportional to and/or indicative of the temperature being measured. Although exemplary positioning of temperature sensors is described herein, it should be appreciated that cooking appliance 100 may include any other suitable number, type, and position of temperature and/or other sensors according to alternative embodiments.

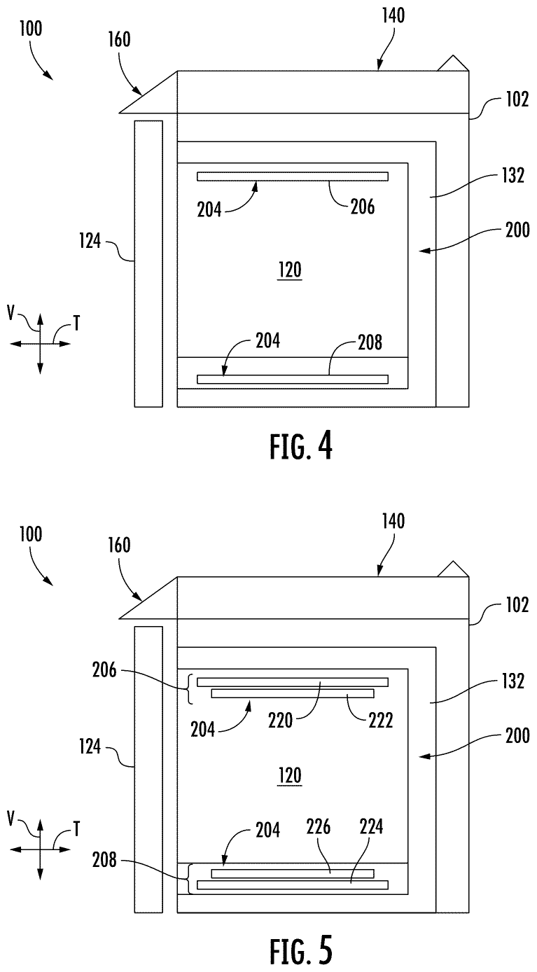

Referring now generally to FIGS. 1 through 5, a heating system 200 of cooking appliance will be described according to an example embodiment of the present subject matter. Cooking appliance 100 may further include one or more heating elements or cooktop heaters (identified generally by reference numeral 202) for selectively heating cooking utensils positioned on glass panel 144. For example, referring to FIG. 1, cooktop heaters 202 may be electric heating elements or induction heating elements. Specifically, a plurality of cooktop heaters 202 are mounted within or on top of top panel 142 underneath a glass panel 144 that supports cooking utensils over the cooktop heaters 202 while cooktop heaters 202 provide thermal energy to cooking utensils positioned thereon, e.g., to heat food and/or cooking liquids (e.g., oil, water, etc.).

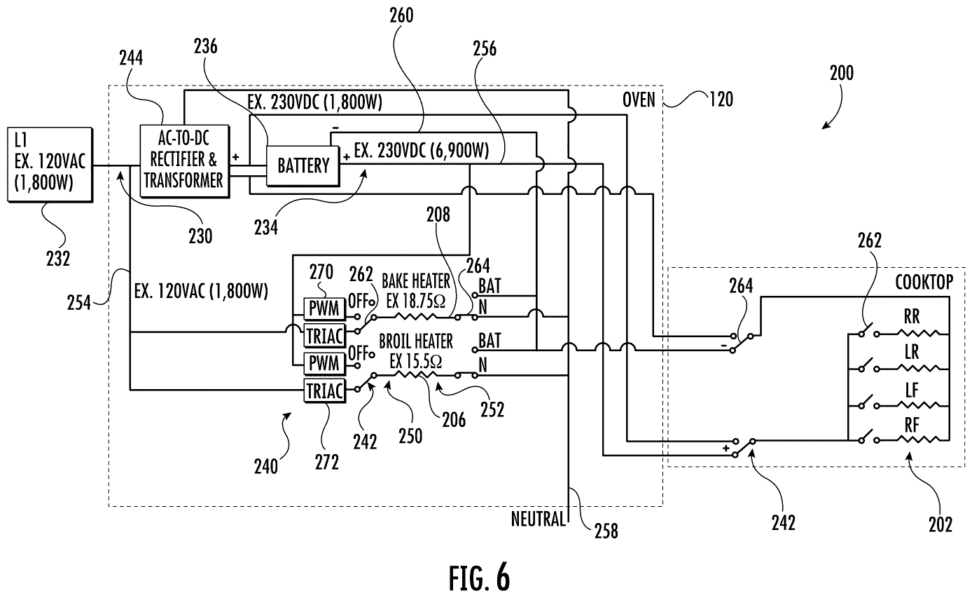

Cooktop heaters 202 can be configured in various sizes so as to provide e.g., for the receipt of cooking utensils (i.e., pots, pans, etc.) of various sizes and configurations and to provide different heat inputs for such cooking utensils. For example, as shown in FIG. 1, cooktop 140 includes five cooktop heaters 202 of different sizes, each of which may be independently controlled to facilitate operation of cooktop 140. By contrast, as shown in the schematic representation of FIG. 6, cooktop 140 may include four cooktop heaters 202, e.g., a rear right heater (RR), a left rear heater (LR), a left front heater (LF), and a right front heater (RF). According to alternative embodiments, cooking appliance 100 may have other cooktop configurations or burner elements.

In addition, cooking appliance 100 may include one or more chamber heaters 204 that may be positioned within or may otherwise be in thermal communication with cooking chamber 120 for regulating the temperature within cooking chamber 120. Specifically, an upper chamber heater, also referred to as a broil heating element 206, may be positioned in cabinet 102, e.g., at a top portion of cooking chamber 120, and a lower chamber heater, also referred to as a bake heating element 208, may be positioned at a bottom portion of cooking chamber 120. Broil heating element 206 and bake heating element 208 may be used independently or simultaneously to heat cooking chamber 120, perform a baking or broil operation, perform a cleaning cycle, etc. The size and heat output of heating elements 206, 208 can be selected based on the, e.g., the size of cooking appliance 100 or the desired heat output. According to example embodiments, broil heating element 206 and bake heating element 208 are electric heating elements. Cooking appliance 100 may include any other suitable number, type, and configuration of heating elements 202 within cabinet 102 and/or on cooktop 140.

In some embodiments, cooking appliance 100 includes a convection heating assembly 210 that operates in conjunction with chamber heaters 204 (e.g., broil heating element 206 and bake heating element 208) to facilitate convection cooking within cooking chamber 120. In this regard, convection heating assembly 210 may operate to circulate a flow of heated air within cooking chamber 120 to facilitate more even heating and shorter cooking cycle times. Although an example convection heating assembly 210 is described below, it should be appreciated that variations and modifications may be made while remaining within the scope of the present subject matter.

As best shown in FIG. 3, convection heating assembly 210 includes a convection fan enclosure 212 positioned proximate a rear of cooking chamber 120. In this regard, convection fan enclosure 212 is defined at least partially by a front wall and a rear wall spaced apart along the transverse direction T. The front wall may define one or more apertures that permit the flow of heated air to pass into and out of convection fan enclosure 212. According to alternative example embodiments, convection fan enclosure 212 may include alternative airflow paths, ducts, or other flow regulating devices for directing the flow of heated air within convection fan enclosure 212 and throughout cooking chamber 120.

As illustrated, convection heating assembly 210 further includes a convection fan 214 mounted in cabinet 102 (e.g., within convection fan enclosure 212) for circulating the flow of heated air in cooking chamber 120. Specifically, convection fan 214 is illustrated as a centrifugal fan, though other suitable fan types and configurations are possible and within the scope of the present subject matter. A drive motor 216 may be mounted to cabinet 102 and may be mechanically coupled to convection fan 214 for selectively rotating convection fan 214. Controller 166 may be in operative communication with drive motor 216 for selectively rotating convection fan 214 at desired times within a cooking cycle.

Referring now specifically to FIG. 5, each chamber heater 204 may include two or more heating stages that may be powered collectively or independently depending on the heating needs of cooking chamber 120 or the power available to cooking appliance 100. For example, as illustrated, broil heating element 206 may include a first heating stage 220 and a second heating stage 222. Similarly, bake heating element 208 may include a first heating stage 224 and a second heating stage 226. In general, the term “heating stages” may refer to subsets of chamber heaters 204 that are positioned adjacent to each other on the same face of the oven chamber or are embodied as a single heating element but which may be independently operated. According to example embodiments, these heating stages may each include different resistances, thereby facilitating versatility in the heating power applied through chamber heaters 204. Other variations and modifications to chamber heaters 204 and their respective heating stages are possible and within the scope of the present subject matter.

Referring now to FIG. 6, an electrical schematic view of heating system 200 will be described according to example embodiments of the present subject matter. As shown, heating system 200 may include a main power connection 230 to a main supply 232 of electrical power and an auxiliary power connection 234 to a battery supply 236. In this regard, cooking appliance 100 may be an electric oven that facilitates battery-assisted cooking. According to an example embodiment, main supply 232 may provide power at a first voltage (e.g., 120 VAC) and battery supply 236 may provide power at a second voltage (e.g., 230 VDC). It should be appreciated that these supply voltages may vary, and additional or alternative power sources may be incorporated into heating system 200 while remaining within the scope of the present subject matter.

According to example embodiments, main supply 232 may be mains electricity, e.g., provided by a utility provider to a conventional 120 VAC outlet within a user's residence. Battery supply 236 may be a battery supply or battery bank stored within cabinet 102 of cooking appliance 100 or may be a home battery supply electrically coupled or wired to cooking appliance 100. According to example embodiments, controller 166 may have a communication link with battery supply 236 (e.g., a remote connection with the home battery supply) for receiving operating parameters of battery supply 236, e.g., such as operating voltage, a maximum battery supply power draw, or other useful information.

As noted above, conventional cooking appliances that include electric heating elements in the oven chamber and electric heating elements on the cooktop are powered by a main electricity supply. However, a user's kitchen may be wired for a first voltage (e.g., 120 VAC for a gas range), requiring rewiring by an electrician to use a conventional electric oven, cooktop, and/or range that operates at a second voltage (e.g., 240 VAC). Accordingly, purchasers of electric cooking appliances that operate at a second voltage may be disappointed when their product cannot be used when installed or may need to hire an electrician to rewire prior to operation. Heating system 200 may solve this problem by facilitating operation at a higher voltage, e.g., via use of power electronics and a higher voltage battery supply 236. Aspects of the present subject matter are directed to heating system 200 and power control systems and methods for facilitating such battery-assisted operation of cooking appliance 100.

In this regard, referring still to FIG. 6, heating system 200 may include a power switching system 240 configured to selectively couple main supply 232 and battery supply 236 to various heating elements of heating system 200. In this regard, power switching system 240 may include one or more switches 242, power electronics, power busses, and other electricity regulating devices for controlling the flow of power throughout heating system 200. In this regard, switches 242 may include single pole double throw relays, double pole double throw relays, contactors, transistors, or any other suitable devices for toggling, switching, or regulating the flow of electricity.

Power switching system 240 may also include a power electronics system 244 for converting alternating current (AC) power to direct current (DC) power or for converting DC power to AC power. For example, power electronics system 244 may include one or more inverters, rectifiers, voltage transformers, or other power electronics devices for converting power from AC to DC power (and vice versa), for adjusting voltage output, or for otherwise regulating or manipulating the flow of electricity as needed based on the call for heat from heating system 200.

According to the illustrated example embodiments, each heating element in heating system 200 (e.g., cooktop heaters 202 and chamber heaters 204) may include a high-voltage side 250 and a low-voltage side 252. Power switching system 240 may operate to selectively couple high-voltage sides 250 with a line connection 254 of main supply 232 or a positive terminal 256 of battery supply 236, e.g., based on a command from controller 166. Similarly, power switching system 240 may operate to selectively couple low-voltage sides 252 with a neutral line 258 of main supply 232 or a negative terminal 260 of battery supply 236, e.g., based on a command from controller 166.

As explained above, power switching system 240 includes one or more switches 242 to route power within power switching system 140 and heating system 200. For example, as illustrated in FIG. 6, switches 242 may include a high-side switch 262 for selectively coupling high-voltage side 250 of a particular heating element to line connection 254 of main supply 232 or positive terminal 256 of battery supply 236. In addition, switches 242 may include a low-side switch 264 for selectively coupling low-voltage side 252 to neutral line 258 of main supply 232 or negative terminal 260 of battery supply 236. As illustrated, high-side switches 262 and low-side switches 264 may be used to selectively route power to one or more cooktop heaters 202 and/or one or more chamber heaters 204.

According to another example embodiment, instead of having a high-side switch 262 and a low side switch 264 for each of two heating elements (e.g., four total switches), a first chamber heater, e.g., such as broil heating element 206, may be hard-wired to negative terminal 260 of battery supply 236, and a second chamber heater, e.g., such as bake heating element 208, may be hard-wired to neutral line 258 of main supply 232. According to such an embodiment, power switching system 240 may include a single battery supply switch for selectively coupling first heating element (e.g., broil heating element 206) to battery supply 236 and a line supply switch for selectively coupling the second heating element (e.g., bake heating element 208) to main supply 232.

In addition, power switching system 240 may use the same or similar features to regulate the flow of power to cooktop heaters 202 of cooktop 140. In this regard, power switching system 240 may include a high-side switch 262 for selectively coupling a high-voltage side 250 of the plurality of cooktop heaters 202 to line connection 254 of main supply 232 (e.g., through power electronics system 244 or a transformed line connection) or positive terminal 256 of battery supply 236. Similarly, power switching system 240 may include a low-side switch 264 for selectively coupling low-voltage side 252 of the plurality of cooktop heaters 202 to neutral line 258 of main supply 232 (e.g., through power electronics system 244 or a transformed line connection) or negative terminal 260 of battery supply 236. Other switching configurations are possible and within the scope of the present subject matter.

As will be explained in more detail below, controller 166 may be in operative communication with power switching system 240 to regulate power flow based at least in part on the call for heat from each respective heating element (e.g., cooktop heaters 202 and/or chamber heaters 204). In this regard, controller 166 may be configured to receive a call for heat from the heating element (e.g., based on a user input via control inputs 162, a change in system state, etc.), determine a power schedule utilizing at least one of main supply 232 or battery supply 236, and operate power switching system 240 to deliver power to the heating element from at least one of 232 main supply or battery supply 236 in accordance with the power schedule. According to an example embodiment, the power schedule minimizes power drawn from battery supply 236. In addition, in cases where a chamber heater 204 includes two stages, the power schedule may include powering first stage 220/224 using only battery supply 236 and powering second stage 222/226 using only main supply 232.

Referring still to FIG. 6, some or all of broil heating element 206, bake heating element 208, cooktop heaters 202, or other heating elements of cooking appliance 100 may be electrically coupled to main supply 232 and/or battery supply 236 through one or more voltage controllers. In this regard, as illustrated, broil heating element 206 and bake heating element 208 may be coupled to the battery supply 236 through a pulse width modulation (PWM) controller 270. In addition, or alternatively, broil heating element 206 and bake heating element 208 may be coupled to main supply 232 through a triode for alternating current (TRIAC) 272. Each of these voltage regulators will be described in more detail below. Although the battery voltage controller is described herein as PWM controller 270, it should be appreciated that other devices may be used to regulate power or voltage from the power supplies, e.g., such as an output transformer, other relays or electronic devices, etc.

In general, the PWM controller regulates the applied power or voltage by adjusting the width of its output pulses. The output of a PWM controller is commonly referred to as a duty cycle, where a waveform defines ON periods and OFF periods of power generation. For example, PWM may switch the main supply 232 or the battery supply 236 between 0 and 100% voltage and at a faster rate than the load can change significantly. The longer the supply is switched on, the higher the total power supplied to the load, e.g., the heating element. Thus, the duty cycle of PWM controller may be roughly proportional to the power supplied to the load (e.g., between 0 and 100%).

In general, the TRIAC may be a type of thyristor that regulates the applied power applied to a load, e.g., by varying the output voltage. This power may be regulated by controller 166, e.g., by applying a voltage at the control gate of the TRIAC, which thereby permits current to flow. Further detail regarding the operation of TRIACs would be understood to one having ordinary skill in the art, so further details are omitted here for brevity.

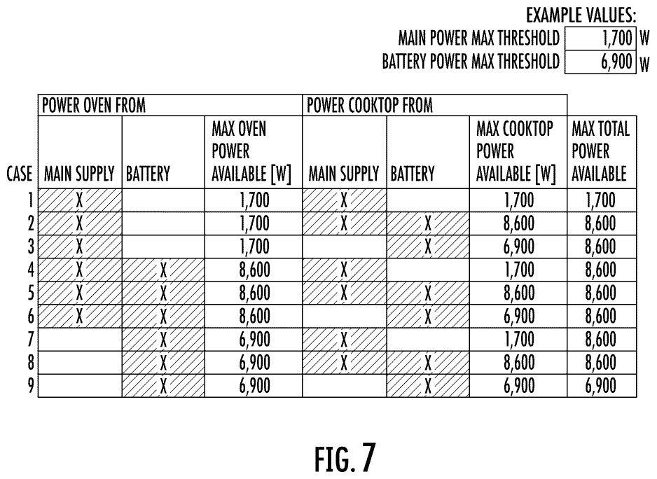

Referring now to FIG. 7, various power supply scenarios for powering cooktop heaters 202 and/or chamber heaters 204 using main supply 232 and/or battery supply 236 will be described according to an example embodiment. For example, because each of cooktop heaters 202 and/or chamber heaters 204 may be powered by main supply 232, battery supply 236, or both, the total number of power supply scenarios may include nine scenarios, as shown in FIG. 7. To facilitate discussion, example max available power thresholds are provided for each of main supply 232 and battery supply 236. In this regard, the maximum main supply power threshold of main supply 232 may be 1,700 Watts and the maximum battery supply power threshold of battery supply 236 may be 6,900 Watts. As shown, for each power supply scenario, there is a maximum total power available to both cooktop heaters 202 and/or chamber heaters 204 (i.e., listed in the last column of FIG. 7). It should be appreciated that the power values provided are only exemplary and are not intended to limit the scope of the present subject matter in any manner.

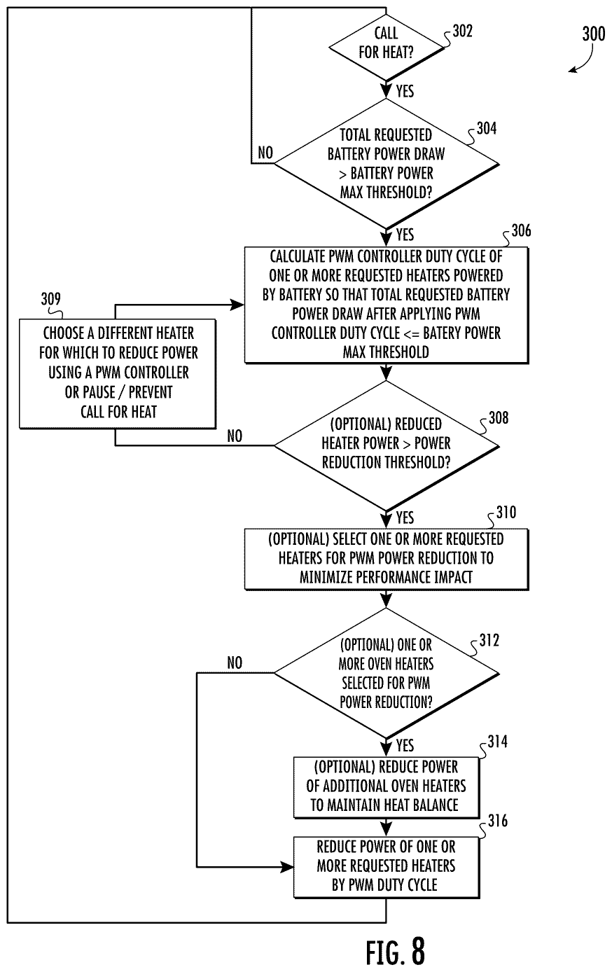

Referring now to FIG. 8, an example method 300 of operating a battery-assisted heating system in a cooking appliance will be described according to an example embodiment. For example, method 300 may be used to operate heating system 200 of a cooking appliance to maintain battery power draw at or below a battery power maximum threshold. As shown, step 302 includes determining whether there is a call for heat from the cooking appliance. In this regard, for example, cooking appliance 100 is “calling for heat” when one or more electric heaters (e.g., cooktop heaters 202, broil heating elements 206, and/or bake heating elements 208) are intended to be activated and draw power from one or more power supplies (e.g., main supply 232 and/or battery supply 236). This call for heat may be initiated by a user (e.g., using user interface panel 160 or control inputs 162), by controller 166, or in any other suitable manner.

If there is a call for heat, step 304 may include determining that a total requested battery power draw associated with the call for heat is greater than a battery power maximum threshold. The battery power maximum threshold may be pre-programmed, set by a user, and/or adjusted automatically based on a measured value (e.g. battery temperature) and/or the state of the cooking appliance. If the requested battery power draw exceeds the battery power maximum threshold, step 306 includes calculating a reduced battery power draw that is less or equal to the battery power maximum threshold, e.g., ensuring that the power drawn from the battery does not exceed the battery power maximum threshold. For example, when PWM controller 270 is used, step 306 may include calculating a PWM duty cycle for the PWM controller that supplies the reduced battery power draw from the battery supply. As explained above, the duty cycle may be lowered to reduce the power draw from battery supply 234, e.g., until the reduced battery power draw is achieved. If other voltage controllers are used, they may be regulated as needed to reduce the battery power to the reduced battery power draw.

According to example embodiments, it may be desirable to limit the reduction in the power draw from the battery to ensure desirable appliance performance is maintained. Accordingly, step 308 may include determining that a difference between the total requested battery power draw and the reduced battery power draw exceeds a power reduction threshold. If the difference exceeds a certain power reduction threshold or a percentage thereof, step 309 may include choosing a different heater for which to reduce power using a PWM controller, preventing operation of the battery voltage controller to deliver power beyond the reduced battery power draw, or pausing or preventing the call for heat.

At optional step 310, if multiple heaters involved in the call for heat may have their power reduced using a PWM controller and satisfy power reduction threshold condition 308, one or more of the heaters may be selected for power reduction may be selected based on minimizing its impact to heating performance. For example, if both a cooktop and an oven heater have calls for heat, and both may be adjusted with a PWM controller to maintain battery power draw below the battery power maximum threshold without exceeding a power reduction threshold, then the oven heater may be selected for power reduction to minimize the impact on cooktop heating performance (or vice versa).

In order to ensure even and satisfactory cooking performance within cooking chamber 120, method 300 may further include steps to ensure even and consistent heating of cooking chamber 120. In this regard, step 312 may include determining whether one or more oven heaters (e.g., broil heating element 206 or bake heating element 208) is selected for power reduction, and if one of the oven heaters is selected, step 314 may include reducing power to one or more additional oven heaters to maintain heat balance within a cooking chamber. Step 316 may include operating the battery voltage controller to supply the reduced battery power draw to the one or more electric heaters.

In this regard, for example, the battery supply can deliver up to 6,900 W of power and the main supply can deliver up to 1,700 W. A user selects both an oven preheat operation and a combination of cooktop heater settings that cause the battery power draw to exceed the battery power maximum threshold of 6,900 W, as described below. During an oven preheat operation, oven settings provide an average power of 2,948 W with a heat balance of 69% bottom heat and 31% top heat. This is executed by powering an 18.75 ohm bake heater for 61% of the preheat operation from the 230 VDC battery (providing 2,821 W) and 39% of the preheat operation from the 120 VAC main supply (providing 768 W). In addition, a 15.50 ohm broil heater is powered for 100% of the preheat operation from the 120 VAC main supply (929 W). While the oven preheat operation is active, a user may also set a cooktop to deliver 3,700 W from the right front heater and 600 W from the left front heater (both powered by the battery). The maximum power draw from the battery is 2,821 W+3,700 W+600 W=7,121 W, exceeding the battery power max threshold of 6,900 W by 221 W. A PWM controller can be used to reduce power to one or more heaters so that total battery power draw is less than the battery power max threshold of 6,900 W. For example, the PWM controller can reduce power from the battery to the bake heater from 2,821 W to 2,600 W by adjusting its PWM duty cycle from 100% to 92%. This reduces average oven preheat power from 2,948 W to 2,814 W, extending preheat time to Bake 350F from 12.0 to 12.5 min. Alternatively, the PWM controller can reduce right-front cooktop heater power from 3,700 W to 3,479 W by adjusting its PWM duty cycle from 100% to 94%. This increases the time to boil 2 L of water from 3.3 min to 3.5 min.

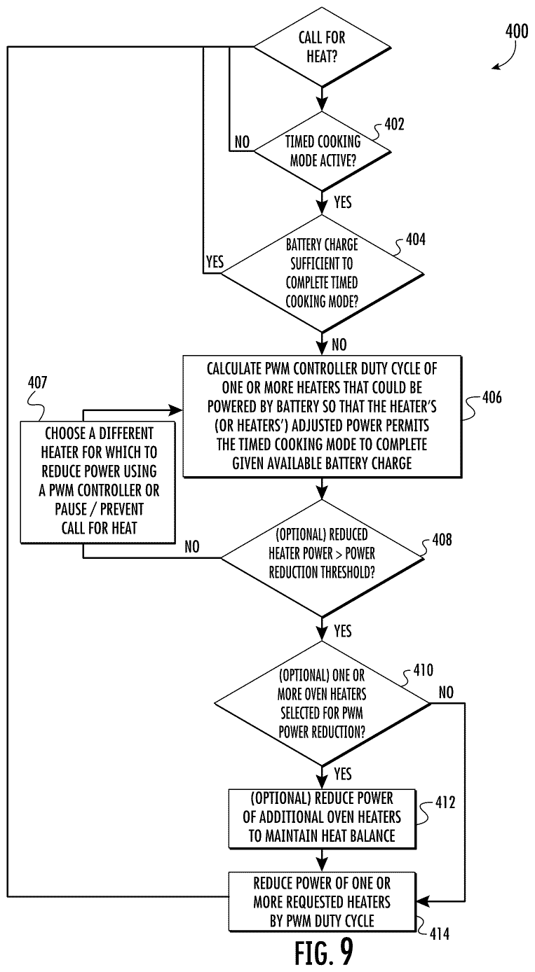

Referring now to FIG. 9, aspects of the present subject matter may also be directed to method 400 of extending operation of a cooking appliance even when an associated battery supply has low charge. Method 400 may include, at step 402, determining that a timed cooking mode is active. In this regard, a timed cooking mode may refer to any cooking procedure that is initiated where there is an associated cooking time, e.g., a predetermined or user-defined duration of the cooking process.

If the timed cooking mode is active, step 404 may include determining whether the battery charge is sufficient to complete the timed cooking mode. In this regard, by knowing the duration of the timed cooking mode and the heater power levels, the required battery power may be calculated and compared to the available battery power (e.g., based on its state of charge).

If the battery charge is sufficient, the timed cooking mode will be completed using normal operating parameters. However, if step 404 results in a determination the battery charge is insufficient, step 406 may include calculating a modified power draw that permits that timed cooking mode to complete using the battery charge. In this regard, step 406 may include calculating a PWM controller duty cycle of one or more heaters that could be powered by the battery so that the heater's or heaters'adjusted power permits the timed cooking mode to compete given the available battery charge.

Step 408 may be the same or similar to step 308, e.g., ensuring that the power reduction does not exceed a predetermined threshold. If the difference exceeds a certain power reduction threshold or a percentage thereof, step 409 (similar to step 309) may include choosing a different heater for which to reduce power using a PWM controller, preventing operation of the battery voltage controller the reduced battery power draw, or pausing or preventing the call for heat.

Step 410 may be the same or similar to step 312, e.g., determining whether one of the oven heaters (e.g., broil heating element 206 or bake heating element 208) is part of the timed cooking mode. Step 412 may be the same or similar to step 314, e.g., reducing power to one or more additional oven heaters in order to maintain heat balance within the oven chamber. Step 414 may include operating the battery voltage controller to supply the modified power draw to the one or more electric heaters, e.g., by limiting heater power using the PWM duty cycle calculated at step 406.

Aspects of the present subject matter may also be directed to extending operation of a cooking appliance when an associated battery is at low charge. For example, the maximum power of one or more heaters may be reduced to enable a timed cooking mode to complete. For example, the battery supply may have 2.3 kW*hr of energy remaining. A user selects both a timed oven cooking mode and a cooktop heater setting. The timed oven mode consumes an average of 300 W of battery power and will complete in 60 min (requiring 0.3 kW*hr of energy). The cooktop heater is set to provide 3,000 W and is powered by the battery. The battery charge is calculated to be insufficient to complete the timed cooking mode using these settings (2.3 kW*hr divided by [300 W+3,000 W]=41.8 min, which is less than the 60 min timed oven cooking mode duration. In response, the cooktop heater is limited to 2,000 W using the PWM controller (by adjusting the PWM duty cycle to 66%), reducing its energy consumption during the 60 min timed oven mode to 2.0 kW*hr and enabling the timed oven cooking mode to complete.

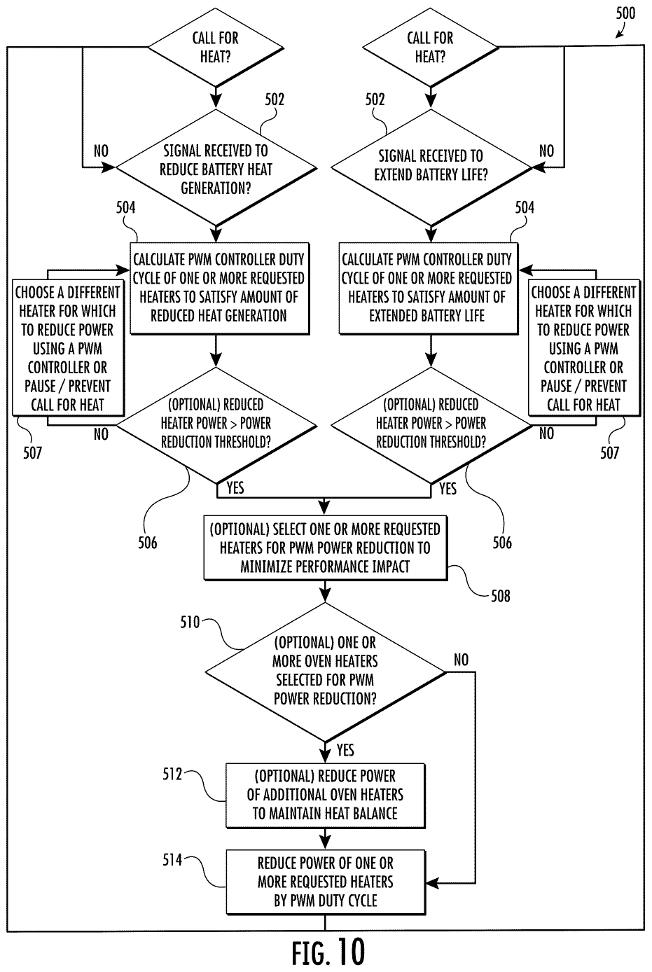

Referring now to FIG. 10, aspects of the present subject matter may also be directed to method 500 of extending operation of a cooking appliance in a manner that maintains the health (e.g. by reducing battery heat generation) and/or extends the life of the battery supply, e.g., by reducing the battery power draw intensity. Method 500 may include, at step 502, receiving a signal to reduce battery heat generation or extend battery life of the battery supply. Step 504 may include calculating a modified power draw that reduces the heat generation or extends the battery life of the battery supply. For example, the measured temperature of the battery may be near its rated limit due to battery self-heating, and a signal may be generated calling for battery current/power draw to be reduced to maintain the battery temperature below its rated limit.

Step 506 may be the same or similar to steps 308 and 408, e.g., ensuring that the power reduction does not exceed a predetermined threshold. If the difference exceeds a certain power reduction threshold or a percentage thereof, step 507 (similar to steps 309 and 409) may include choosing a different heater for which to reduce power using a PWM controller, preventing operation of the battery voltage controller to provide power beyond the reduced battery power draw, or pausing or preventing the call for heat.

At optional step 508 (e.g., the same or similar to step 310), if multiple heaters involved in the call for heat may have their power reduced using a PWM controller and satisfy power reduction threshold condition 308, one or more of the heaters may be selected for power reduction may be selected based on minimizing its impact to heating performance. For example, if both a cooktop and an oven heater have calls for heat, and both may be adjusted with a PWM controller to maintain battery power draw below the battery power maximum threshold without exceeding a power reduction threshold, then the oven heater may be selected for power reduction to minimize the impact on cooktop heating performance (or vice versa).

Step 510 may be the same or similar to steps 312 and 410, e.g., determining whether one of the oven heaters (e.g., broil heating element 206 or bake heating element 208) is part of the timed cooking mode. Step 512 may be the same or similar to step 314 and 412, e.g., reducing power to one or more additional oven heaters in order to maintain heat balance within the oven chamber. Step 514 may include operating the battery voltage controller to supply the reduced battery power draw to the one or more electric heaters.

For example, during a period in which an oven heater is powered by the battery and a signal is received to reduce battery heat generation, its power may be reduced by reducing a PWM controller's duty cycle. In cases where the heater is cycled on and off during a call for heat, the heater's operating time may also optionally be extended so that total energy delivered by the mode remains the same. For example, an oven may provide an average power of 1,211 W during a call-for-heat. Without a PWM controller, oven heaters may satisfy this call-for-heat by powering an 18.75 ohm bake heater from a 230 VDC battery (providing 2,821 W) for 16% of the call-for-heat time and from a 120 VAC main supply (providing 768 W) for 63% of the call-for-heat time. A 15.50 ohm broil heater may be powered by a 120 VAC main supply (providing 928 W) for 30% of the call for heat. A PWM controller at 50% duty cycle may be used to reduce the bake heater's power provided from the battery from 2,821 W to 1,410 W. To preserve total energy delivery from the bake heater, oven settings may be adjusted to power the bake heater from a 230 VDC battery at a PWM duty cycle of 50% (providing 1,410 W) for 32% of the call-for-heat and from a 120 VAC main supply (providing 768 W) for 63% of the call-for-heat time. The broil heater behavior is unchanged, being powered by a 120 VAC main supply (providing 928 W) for 30% of the call-for-heat time.

According to another example embodiment, the cooking appliance may include one or more TRIACs (triode for alternating current) that switch power to one or more heaters when these heaters are powered by the main supply. Reducing the TRIAC duty cycle reduces the power consumed by the heater. The controller of the cooking appliance may use the TRIAC to reduce the power of a first heater driven by the main supply to enable operation of a second heater driven by the main supply, where the second heater would otherwise be driven by the battery. The TRIAC controller thus maximizes power drawn from the main supply and/or reduces use of battery power. This power reduction may be limited to a power reduction threshold. Oven heat settings for additional heaters may be adjusted along with the one or more heaters adjusted by a TRIAC duty cycle (ex. to maintain oven top-to-bottom heat balance). The power reduction may be performed automatically or in response to a user selection.

According to an example embodiment, the one or more electric heaters comprises a chamber heater and a cooktop heater. The controller may be further configured to determine that a total requested power draw from the main supply to the chamber heater is less than a maximum main supply power draw, determine an alternative power distribution scheme that supplies the maximum main supply power draw from the main supply to both the chamber heater and the cooktop heater, and distribute power in accordance with the alternative power distribution scheme. For example, the alternative power distribution scheme may comprise reducing power to the chamber heater using the TRIAC and changing the power source of the cooktop heater from the battery to the main supply. Alternatively or additionally, main supply power to a cooktop heater may be reduced and the power source of a chamber heater may be changed from battery to main supply. Similar approaches may be taken for two or more chamber heaters and/or two or more cooktop heaters.

For example, the main supply can deliver up to 1,700 W. A user selects an oven preheat operation and sets a cooktop heater to provide 900 W of power. The oven preheat settings power an 18.75 ohm bake heater from a 230 VDC battery supply (providing 2,821 W) for 61% of the preheat operation and from a 120 VAC main supply (providing 768 W) for 39% of the preheat operation. A 15.5 ohm broil heater is powered by a 120 VAC main supply (providing 928 W) for 100% of the preheat operation. The cooktop heater is powered by the battery. A TRIAC controller may be used to reduce the power provided by the main supply to the broil heater from 928 W to 800 W using an 86% TRIAC duty cycle, permitting both the broil heater and cooktop heat to be powered by the main supply without exceeding its rated maximum of 1,700 W (800 W broil heater+900 W cooktop heater=1,700 W). During the 61% of the preheat operation where the bake heater is powered by the battery, the cooktop power source is changed from the battery to the main supply. This reduces battery power draw and maximizes use of main supply power.

Another benefit of presently disclosed methods is that it enables use of higher-power (lower-resistance) heaters to improve performance. These heaters are operated at lower power (using a TRIAC at <100% duty cycle) when high power is not required, and/or to maximize use of main supply power. For example, the main supply can deliver up to 1,700 W. An oven without a heater TRIAC includes a Bake Heater 18.75 ohms (2,821 W at 230V, 768 W at 120V) and Broil Heater 15.50 ohms (3,409 W at 230V, 928 W at 120V). Both the bake and broil heater can operate at the same time when powered by the main supply (totaling 1,700 W), maximizing use of line power. However, the broil heater's max power is limited to 3,409 W (when powered by the battery). Changing the broil heater resistance from 15.50 ohms to 13.23ohms increases broil heater max power from 3,409 W to 4,000 W (when powered by the battery), improving performance. When this broil heater power is driven by the 120 VAC main supply, its power is 1,088 W and if it were powered at the same time as the bake heater their total power would exceed the main power max threshold. Adding a TRIAC to the broil heater and adjusting its duty cycle to 85% reduces the broil heater power 925 W, enabling it to be operated at the same time as the bake heater and maximizing use of main supply power.

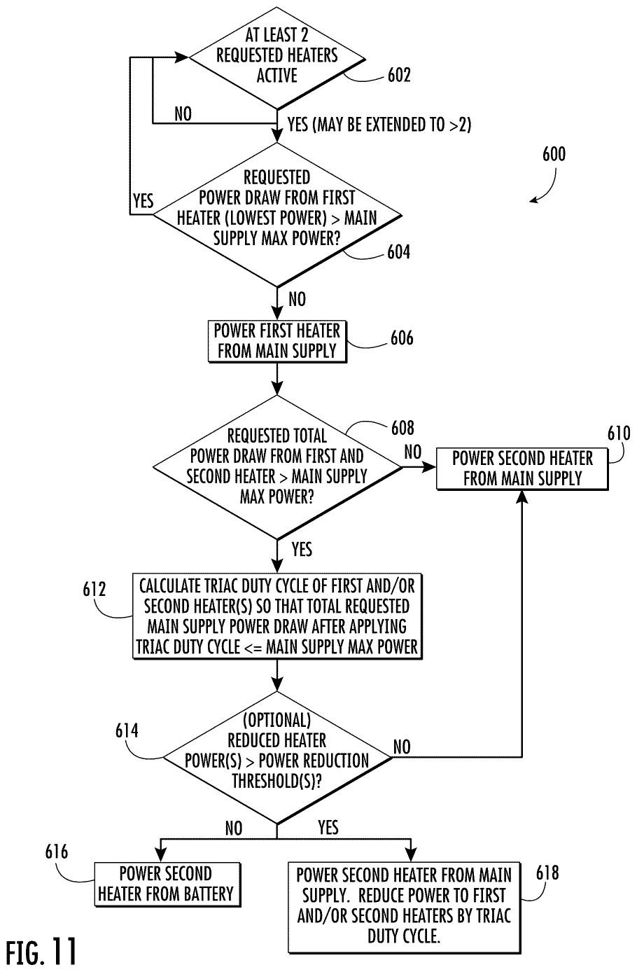

Referring now briefly to FIG. 11, aspects of the present subject matter may also be directed to method 600 of operating a heating system. Method 600 includes, at step 602, determining that at least two heaters have an active call for heat, i.e., the controller has requested that these two or more heaters be energized. If at least two heaters are active, step 604 includes determining whether the requested power draw from a first heater (e.g., the heater with the lowest power rating) is greater than the main supply maximum power threshold. If the requested power draw is lower than this threshold, step 606 includes powering the first heater from the main supply.

Step 608 includes determining whether the requested power draw from both the first heater and a second heater is greater than the main supply maximum power threshold. If the combined requested power draw is lower than this threshold, step 610 includes powering the first heater and the second heater from the main supply. By contrast, if the combined requested power draw is higher than this threshold, step 612 includes calculating a TRIAC duty cycle of the first and/or second heaters so that the total requested main supply power draw after applying the TRIAC duty cycle is less than or equal to the main supply maximum power threshold.

Step 614 may be the same or similar to steps 308, 408, and 506, e.g., ensuring that the power reduction does not exceed a predetermined threshold. If the difference does not exceed a certain power reduction threshold or a percentage thereof, step 610 again includes powering the second heater from the main supply. Alternatively, if the difference does not exceed a certain power reduction threshold or a percentage thereof, step 616 may include powering the second heater from the battery By contrast, if the difference exceeds the power reduction threshold or a percentage thereof, step 618 includes powering the second heater from the main supply and reducing power to the first and/or second heaters by utilizing the TRIAC duty cycle.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooking appliance comprising:
one or more electric heaters;
a main power connection to a main supply of electrical power at a first voltage;
an auxiliary power connection to a battery supply of electrical power at a second voltage;
a voltage controller for regulating the electrical power from the battery supply; and
a controller operably coupled to the voltage controller, the controller being configured to:
receive a call for heat requesting activation of at least one of the one or more electric heaters;
determine that a total requested battery power draw associated with the call for heat is greater than a battery power maximum threshold;
calculate a reduced battery power draw that is less than or equal to the battery power maximum threshold; and
operate the voltage controller to supply the reduced battery power draw to the one or more electric heaters.

2. The cooking appliance of claim 1, wherein the voltage controller is a pulse width modulation (PWM) controller.

3. The cooking appliance of claim 2, wherein calculating the reduced battery power draw comprises:
calculating a PWM duty cycle for the PWM controller that supplies the reduced battery power draw from the battery supply.

4. The cooking appliance of claim 1, wherein the voltage controller is an output transformer.

5. The cooking appliance of claim 1, wherein the controller is further configured to:
determine that a difference between the total requested battery power draw and the reduced battery power draw exceeds a power reduction threshold; and
choose a different heater for which to reduce power or pause or prevent the call for heat.

6. The cooking appliance of claim 1, wherein the controller is further configured to:
determine that the at least one of the one or more electric heaters is selected for power reduction; and
reduce power to one or more additional electric heaters to maintain heat balance within a cooking chamber.

7. The cooking appliance of claim 1, wherein the controller is further configured to:
determine that a timed cooking mode is active;
determine that a battery charge of the battery supply is not sufficient to complete the timed cooking mode;
calculate a modified power draw that permits that timed cooking mode to complete using the battery charge; and
operate the voltage controller to supply the modified power draw to the one or more electric heaters.

8. The cooking appliance of claim 1, wherein the controller is further configured to:
receive a signal to reduce heat generation or extend battery life of the battery supply;
calculate a modified power draw that reduces the heat generation or extends the battery life of the battery supply; and
operate the voltage controller to supply the modified power draw to the one or more electric heaters.

9. The cooking appliance of claim 1, further comprising a triode for alternating current (TRIAC) for regulating the electrical power from the main supply, wherein the one or more electric heaters comprises a first heater and a second heater, and wherein the controller is further configured to:
determine that a requested power draw to the first heater is less than a maximum main supply power draw;
determine an alternative power distribution scheme that delivers a total main supply power draw, which is greater than the requested power draw to the first heater, to the first heater and the second heaters; and
distribute power in accordance with the alternative power distribution scheme.

10. The cooking appliance of claim 9, wherein determining the alternative power distribution scheme comprises reducing a power to the first and/or second heater using the TRIAC and powering the first and second heaters from the main supply.

11. The cooking appliance of claim 1, wherein the first voltage is 120 VAC and the second voltage is 230 VDC.

12. The cooking appliance of claim 1, wherein the battery supply is a battery stored within the cooking appliance.

13. The cooking appliance of claim 1, wherein the battery supply is a home battery supply in communication with the cooking appliance.

14. A method of operating a cooking appliance, the cooking appliance comprising a one or more electric heaters, a main power connection to a main supply of electrical power at a first voltage, an auxiliary power connection to a battery supply of electrical power at a second voltage, and a voltage controller for regulating the electrical power from the battery supply, the method comprising:
receiving a call for heat requesting activation of at least one of the one or more electric heaters;
determining that a total requested battery power draw associated with the call for heat is greater than a battery power maximum threshold;
calculating a reduced battery power draw that is less than or equal to the battery power maximum threshold; and
operating the voltage controller to supply the reduced battery power draw to the one or more electric heaters.

15. The method of claim 14, wherein the voltage controller is a pulse width modulation (PWM) controller.

16. The method of claim 15, wherein calculating the reduced battery power draw comprises:
calculating a PWM duty cycle for the PWM controller that supplies the reduced battery power draw from the battery supply.

17. The method of claim 14, further comprising:
determining that a difference between the total requested battery power draw and the reduced battery power draw exceeds a power reduction threshold; and
choosing a different heater for which to reduce power or pause or prevent the call for heat.

18. The method of claim 14, further comprising:
determining that the at least one of the one or more electric heaters is selected for power reduction; and
reducing power to one or more additional electric heaters to maintain heat balance within a cooking chamber.

19. The method of claim 14, further comprising:
determining that a timed cooking mode is active;
determining that a battery charge of the battery supply is not sufficient to complete the timed cooking mode;
calculating a modified power draw that permits that timed cooking mode to complete using the battery charge; and
operating the voltage controller to supply the modified power draw to the one or more electric heaters.

20. A cooking appliance comprising:
one or more electric heaters;
a main power connection to a main supply of electrical power at a first voltage;
an auxiliary power connection to a battery supply of electrical power at a second voltage;
a voltage controller for regulating the electrical power from the battery supply; and
a controller operably coupled to the voltage controller, the controller being configured to:
determine that a timed cooking mode is active;
determine that a battery charge of the battery supply is not sufficient to complete the timed cooking mode;
calculate a modified power draw that permits that timed cooking mode to complete using the battery charge; and
operate the voltage controller to supply the modified power draw to the one or more electric heaters.
